(19) United States
(12) Patent Application Publication
(10) Pub. No.: US 2010/0193984 A1
(43) Pub. Date: Aug. 5, 2010

(54) FOAM SHEET-FORMING COMPOSITION, HEAT CONDUCTIVE FOAM SHEET AND PROCESS

(75) Inventors: Yuji Hiroshige, Tokyo (JP); Yoshinao Yamazaki, Tokyo (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/757,181

(22) Filed: Apr. 9, 2010

Related U.S. Application Data
(63) Continuation of application No. 10/595,188, filed on Mar. 21, 2006.

(30) Foreign Application Priority Data
Sep. 25, 2003 (JP) 2003-333705

(51) Int. Cl. B29C 44/04

(52) U.S. Cl. 264/45.3

(57) ABSTRACT

A sheet-forming composition is provided which has a construction comprising a combination of a heat-polymerizable binder component containing at least one (meth)acrylic monomer or its partial polymer, a heat conductive filler, a heat polymerization initiator for the binder component and a foaming agent. A process for making a heat conductive foam sheet also is provided.

### CROSS REFERENCE TO RELATED APPLICATIONS

This application is a continuation of U.S. application Ser. No. 10/595,188, filed Aug. 10, 2004, now pending; which claims priority to Japanese Application No. 2003-333705, filed Sep. 25, 2003, now pending, the disclosure of which is incorporated by reference in their entirety herein.

### TECHNICAL FIELD

The present invention relates to a heat conductive sheet, and more specifically, it relates to a foam sheet-forming composition which is useful for formation of a heat conductive foam sheet, and to a heat conductive foam sheet obtained as a heat polymerized molded article of the composition and a process for its production.

### BACKGROUND

As is well known, electronic and electrical devices such as personal computers employ heat radiating parts such as heat sinks, heat radiating fins, metal radiator plates and the like to allow heat generated by heat generating parts in the devices to escape to the outside. Various heat conductive sheets are also used as heat transfer means between heat generating parts and heat radiating parts.

Heat conductive sheets commonly used in the prior art comprise a silicone resin as the binder component and are filled with a heat conductive filler to increase the heat conductivity. However, silicone resins have drawbacks such as high cost and longer time required for hardening and working, while additional problems that have been noted include adhesion of low molecular weight siloxanes generated from the resin onto the machines, resulting in poor joints. Acrylic resins have also been considered as alternative binder components to silicone resins.

Because heat conductive sheets are sandwiched between heat generating parts and heat radiating parts, the contacts at the interfaces between the sheet and the parts are crucial from the standpoint of heat conductivity. Specifically, inadequate contact can increase the heat resistance at the interfaces and result in reduced heat conductivity of the sheet. A heat conductive sheet must be able to adequately follow not only the steps or pits found in heat generating parts and heat radiating parts, but also fine irregularities (mat surfaces, etc.) on the surfaces of the parts, in order to achieve proper contact. Heat conductive sheets therefore also require flexibility and adhesive properties. Yet another property required of heat conductive sheets is the ability to adhere to parts under minimal load in order to avoid excessive dynamic load on the parts.

The present inventors have considered that foam sheets employing acrylic resins as binders might exhibit favorable performance as heat conductive sheets, but no heat conductive sheets suitable for the present invention have been hitherto proposed.

For example, there has been disclosed a process for producing polymethyl methacrylate foam by mixing methyl methacrylate monomer, a plasticized monomer, a polymerization initiator and a foaming agent, subjecting the mixture to a first heating for polymerization of the monomer to produce a solid containing the foaming agent, and then softening the polymer in the obtained solid and subjecting it to a second heating at a temperature sufficient for activation of the foaming agent (U.S. Pat. No. 4,530,806). However, it is difficult to increase the amount of added fillers to such foaming agent-containing solids (polymers) for improved heat conductivity. In addition, since the polymerization reaction and the foaming reaction are carried out in two steps, the large temperature difference that must be created between the polymerization and foaming temperatures makes it difficult to achieve control of each reaction, while the high foaming temperature can have an adverse effect on the polymer properties.

Incidentally, the following heat conductive sheets in the form of a foamed article have been proposed in patent documents.

A heat radiating material characterized by comprising a heat radiating substance comprising silicon carbide in a foamed layer consisting of a foam composed of a polyolefin resin with open air cells (Japanese Unexamined Patent Publication (Kokai) No. 10-72534). The heat radiating substance can be produced by heating and kneading the resin, heat radiating substance and foaming agent and then creating a seal by press molding and heating it at high temperature. However, the need for a two-stage heating step presents the same problem as in U.S. Pat. No. 4,530,806.

A heat conductive material characterized by being provided with at least a foamable highly heat conductive layer formed from a resin composition comprising a foaming agent which foams at 40° C. or higher and a highly heat conductive filler (Japanese Unexamined Patent Publication (Kokai) No. 2002-317046). The heat conductive material can be produced by mixing an acrylic polymer, heat conductive filler, foaming agent, etc. in a solvent to prepare a coating solution, and then coating the coating solution onto a base material and heating to dry it. However, since the use of a solvent is essential for preparation of the coating solution, the resulting sheet cannot be made to a very high thickness, and it is difficult to fabricate a sheet with a high filler content.

A heat radiating sheet characterized by impregnating a heat radiating base material having continuous air bubbles with a heat radiating substance composed of a heat radiating gel or heat radiating grease, to form a spongy heat radiating body (Japanese Unexamined Patent Publication (Kokai) No. 2003-31980). The heat radiating sheet can be produced by impregnating a urethane foam body with a silicone compounding agent (a thermosetting silicone resin and heat conductive filler) and then heating the silicone compounding agent to hardness. This employs a method of impregnating a urethane foam body with a silicone compounding agent and thus allows easier control of the foam structure, but it is difficult to impregnate silicone compounding agents with high filler contents.

### SUMMARY OF THE INVENTION

The present invention is directed toward solving the aforementioned problems of the prior art.

It is an object of one aspect of the invention to provide a heat conductive sheet which is economical and easy to produce, has excellent heat conductivity, simultaneously satisfies the conditions of flexibility and adhesive properties, and can be adhered onto parts with a minimal load.

It is another object of one aspect of the invention to provide a sheet-forming composition which allows economical and facilitated production of the heat conductive sheet of the invention.

It is yet another object of one aspect of the invention to provide a process for economical and facilitated production of the heat conductive sheet of the invention.

These and other objects of the invention will be readily apparent from the detailed description which follows.

According to one aspect of the invention, there is provided a heat-polymerizable, foam sheet-forming composition used to form heat conductive foam sheets, comprising, in combination, the following components:

a heat-polymerizable binder component comprising at least one (meth)acrylic monomer or its partial polymer,

a heat conductive filler,

a heat polymerization initiator for the binder component, and

a foaming agent.

According to another aspect of the invention, there is provided a heat conductive foam sheet comprising a heat polymerized molded article made from a foam sheet-forming composition of the invention.

According to still another aspect of the invention, there is provided a process for producing a heat conductive foam sheet, comprising:

preparing a foam sheet-forming composition of the invention,

molding the composition into a sheet, and

heating the composition either during or after the sheet-molding step to simultaneously accomplish reactions for heat polymerization of the binder component and foaming of the composition.

As will be readily understood from the following detailed description, the present invention makes it possible to provide a heat conductive sheet which is economical and easy to produce, which requires no use of a solvent for preparation of the sheet-forming composition, which has excellent heat conductivity, which simultaneously satisfies the conditions of flexibility and adhesive properties, and which can be adhered onto parts with a minimal load.

In particular, because the heat conductive sheet of the invention is a foam body, it is highly flexible and exhibits high compressibility under minimal loads. Consequently, the heat conductive sheet of the invention has a satisfactory following property with respect to irregular structures on the surfaces of parts when actually used for electronic or electrical devices, while it is able to adhere to different parts with minimal load when sandwiched between them and can prevent excessive dynamic load on the contacted parts. On the other hand, the compressed bubbles become crushed during actual use, thus preventing reduction in heat conductivity caused by the presence of the bubbles and allowing the expected high level of heat conductivity to be achieved. The inability to add large amounts of heat conductive filler has been a disadvantage for most methods of the prior art, but with the heat conductive sheet of the present invention, the sheet-forming composition can be kept in a relatively low viscosity state even when the heat conductive filler is present in a relatively large amount, thereby facilitating kneading and molding and rendering the production process easier. In addition, since the heat conductive sheet of the present invention has a foam structure it is possible to prevent reduction in flexibility of the sheet and maintain excellent compressibility. It is an extremely notable achievement in the relevant technical field that this invention can provide a heat conductive sheet exhibiting both flexibility and high heat conductivity.

According to the invention, it is possible to provide a sheet-forming composition which is useful for production of the heat conductive sheet of the invention and allows economical and facilitated production of the sheet while requiring no solvent.

According to the invention it is also possible to provide a process for economical and facilitated production of the heat conductive sheet of the invention. In particular, it is not necessary to use a solvent since coating of the sheet material with a solution is not required, and therefore the production steps are shortened, costs are reduced and risk of environmental pollution is eliminated. In addition, since the heat polymerization and foaming reactions of the (meth)acrylic monomer can be carried out in the same heating step, the number of steps can be minimized and the foaming reaction can be adjusted in conformity with the acrylic polymerization reaction behavior to obtain a foam sheet having a foamed structure suitable for a heat conductive sheet.

The foam sheet-forming composition, heat conductive foam sheet and production process therefor according to the invention can be accomplished advantageously in different embodiments. Preferred embodiments for carrying out the invention will be explained hereinafter, however, note that the invention is in no way restricted to these embodiments.

The foam sheet-forming composition of the invention is a composition for formation of a heat conductive foam sheet by heat polymerization using substantially no solvent. By using the composition it is possible to obtain novel heat conductive foam sheets exhibiting both high heat conductivity and flexibility, which have not been obtainable according to the prior art. In addition to being used for a heat conductive foam sheet, the sheet-forming composition of the invention may be utilized as a heat conductive adhesive which is heat polymerized after being filled as a liquid into a location which is to be bonded. The sheet-forming composition of the invention may be either tacky or non-tacky.

The foam sheet-forming composition of the invention comprises, in combination, the following components:

a heat-polymerizable binder component containing at least one (meth)acrylic monomer or its partial polymer,

a heat conductive filler,

a heat polymerization initiator for the binder component, and

a foaming agent.

Each of the constituent components will now be explained.

### Heat Polymerizable Binder Component

The first component is a heat polymerizable binder component. The heat polymerizable binder component comprises at least one (meth)acrylic monomer or its partial polymer as an essential component. Although the heat polymerization initiator described hereunder may also be considered as a type of binder component, it will be referred herein to as a component of the different group.

There are no particular restrictions on the (meth)acrylic monomer or the (meth)acrylic monomer used for the partial polymer, and for most purposes it may be any monomer used to form acrylic polymers. Specifically, any (meth)acrylic monomer having an alkyl group of no more than 20 carbons may be used as the (meth)acrylic monomer, and more specifically there may be mentioned ethylene (meth)acrylate, butyl (meth)acrylate, hexyl(meth)acrylate, 2-ethylhexyl(meth)acrylate, octyl(meth)acrylate, isooctyl(meth)acrylate, decyl(meth)acrylate and dodecyl(meth)acrylate. For increased cohesion of the resulting heat conductive composition, it is preferred to use in combination therewith a (meth)acrylic monomer whose homopolymer glass transition temperature is 20° C. or higher. As such monomers there may be mentioned carboxylic acids and their corresponding anhydrides, such as acrylic acid or its anhydride, methacrylic acid or its anhydride, itaconic acid or its anhydride and maleic acid or its anhydride. Other examples of (meth)acrylic monomers whose homopolymer glass transition temperatures are 20° C. or higher include polar nitrogen-containing materials such as cyanoalkyl(meth)acrylate, acrylamide, substituted acrylamides such as N,N′-dimethylacrylamide, N-vinylpyrrolidone, N-vinylcaprolactam, N-vinylpiperidine and acrylonitrile. Still additional monomers include tricyclodecyl(meth)acrylate, isobornyl(meth)acrylate, hydroxy(meth)acrylate and vinyl chloride. The (meth)acrylic monomer with a glass transition temperature of 20° C. or higher is preferably present in an amount of no greater than 100 parts by weight with respect to 100 parts by weight of the (meth)acrylic monomer having an alkyl group of no more than 20 carbons.

A partial polymer of a (meth)acrylic monomer may also be used as the heat polymerizable binder component, either in place of or together with the aforementioned (meth)acrylic monomer. Because a (meth)acrylic monomer usually has low viscosity by itself, the heat conductive filler can precipitate when mixed with the binder component containing the (meth)acrylic monomer. In such cases, the (meth)acrylic monomer is preferably partially polymerized beforehand to increase the viscosity. The partial polymerization is preferably conducted until a viscosity of from about 100 to 10,000 centipoise (cP) is reached for the heat polymerizable binder component. The partial polymerization may be accomplished by any of various polymerization methods, examples of which include heat polymerization, ultraviolet polymerization, electron beam polymerization, γ-ray polymerization and ionizing irradiation.

A heat polymerization initiator or photopolymerization initiator will generally be used for partial polymerization of the (meth)acrylic monomer. As heat polymerization initiators there may be used organic peroxide free radical initiators such as diacylperoxides, peroxyketals, ketone peroxides, hydroperoxides, dialkylperoxides, peroxyesters and peroxydicarbonates. Specifically, there may be mentioned lauroyl peroxide, benzoyl peroxide, cyclohexanone peroxide, 1,1-bis(t-butylperoxy) 3,3,5-trimethylcyclohexane and t-butylhydroperoxide. Alternatively, a persulfate/bisulfite combination may be used.

As photopolymerization initiators for partial polymerization there may be mentioned benzoin ethers such as benzoin ethyl ether or benzoin isopropyl ether, anisoin ethyl ether and anisoin isopropyl ether, Michler's ketone (4,4′-tetramethyldiaminobenzophenone), or substituted acetophenones such as 2,2-dimethoxy-2-phenylacetophenone (for example, KB-1 by Sartomer or IRGACURE™ 651 by Ciba-Specialty Chemical) and 2,2-diethoxyacetophenone. There may also be mentioned substituted α-ketols such as 2-methyl-2-hydroxypropiophenone, aromatic sulfonyl chlorides such as 2-naphthalenesulfonyl chloride and photoactive oxime-based compounds such as 1-phenone-1,1-propanedione-2-(o-ethoxycarbonyl)oxime. Alternatively, there may be used any desired combinations of the aforementioned heat polymerization initiators or photopolymerization initiators.

Although there are no particular restrictions on the amount of the polymerization initiator used for partial polymerization, it will normally be in the range of about 0.001 to 5 parts by weight to 100 parts by weight of the (meth)acrylic monomer.

Further, the partial polymerization may be conducted using a chain transfer agent in order to control the molecular weight and content of the polymer in the partial polymer obtained by partial polymerization. As examples of suitable chain transfer agents there may be mentioned mercaptanes, disulfides, carbon tetrabromide, carbon tetrachloride and combinations thereof. A chain transfer agent will usually be used in an amount of about 0.01 to 1.0 part by weight to 100 parts by weight of the (meth)acrylic monomer.

### Heat Conductive Filler

The foam sheet-forming composition of the invention comprises a heat conductive filler to confer excellent heat conductivity to the obtained heat conductive foam sheet. With conventional sheet-forming compositions obtained by photopolymerization by ultraviolet rays or the like, it has only been possible to add a heat conductive filler in an amount of less than 45 vol % for white fillers and less than 10 vol % for colored fillers, in order to ensure light permeability for polymerization, but since the sheet-forming composition of the invention is polymerized by heat polymerization to form a sheet, it can contain a heat conductive filler in an amount of 10 vol % or greater based on the total volume of the sheet-forming composition, and preferably about 10 to 90 vol %, regardless of the color of the filler. The amount of the heat conductive filler is more preferably in the range of about 30 to 90 vol %. If the amount of the heat conductive filler is less than 10 vol % the heat conductivity is reduced, while if it is greater than 90 vol % the cohesive strength of the sheet is weaker.

As heat conductive fillers there may be used ceramics, metal oxides, metal hydroxides, metals and the like. As specific heat conductive fillers there may be mentioned aluminum oxide, silicon oxide, magnesium oxide, zinc oxide, titanium oxide, zirconium oxide, iron oxide, silicon carbide, boron nitride, aluminum nitride, titanium nitride, silicon nitride, titanium boride, carbon black, carbon fiber, carbon nanotubes, diamond, nickel, copper, aluminum, titanium, gold, silver and the like. The crystal form may be any hexagonal, cubic or other crystal form which is adopted by chemical species.

In order to enhance the strength of the sheet, a filler surface treated with a silane, titanate or the like may be used. A filler whose surface has been coated with a ceramic, polymer or the like for waterproof coating or insulation coating may also be used. Further, the surface treatment of the filler may be carried out with an integral blending method using a surface treating agent. That is, the filler may be surface treated by mixing a heat-polymerizable binder component and a surface treating agent, followed by adding to the mixture a filler, or by adding, to a mixture of the heat-polymerizable binder component and a filler, a surface treating agent.

The particle size of the filler will normally be about 500 μm or smaller. An excessively large particle size of the filler results in lower sheet strength. It is preferred to use a combination of a group of larger particle size and a group with smaller particle size. The group of smaller particles will reside between the group of larger particles to increase the amount of includable filler. When this mode is employed, the particle size of the larger particle group is preferred to be approximately 10 to 150 μm, and the particle size of the smaller particle group is preferred to be a size smaller than the larger particle group, or less than 10 μm. Here, the term “particle size” refers to the longest lengthwise dimension as measured by a line passing through the center of gravity of the filler.

The shape of the filler may be any regular or irregular shape, and for example, there may be mentioned shapes such as polygonal, cubic, oval, spherical, needle, planar, flaky, rod, whisker or combinations thereof. The particles may also be aggregates of a plurality of crystal particles. The shape of the filler is selected based on viscosity of the heat polymerizable binder component and the desired ease of workability of the final heat conductive composition or heat conductive sheet obtained after polymerization.

An electromagnetic absorbing filler may also be added in order to confer an electromagnetic absorption property. As electromagnetic absorbing fillers there may be mentioned soft ferrite compounds such as Ni—Zn ferrite, Mg—Zn ferrite and Mn—Zn ferrite, soft magnetic metals such as carbonyl powder, Fe—Si—Al alloy (sendust), or carbon. Since an electromagnetic absorbing filler is also a heat conductive filler, the electromagnetic absorbing filler may be used either alone or in admixture with a heat conductive filler.

### Heat Polymerization Initiator

The foam sheet-forming composition of the invention comprises a heat polymerization initiator to initiate polymerization of the (meth)acrylate monomer or to initiate further polymerization of the partial polymer of the (meth)acrylic monomer. The heat polymerization initiator will normally be added together with the aforementioned heat polymerizable binder component. For use with the partial polymerized (meth)acrylic monomer, the heat polymerization initiator is added to the partial polymer or a mixture of the partial polymer with its monomer, after the partial polymerization.

Organic peroxide compounds may be advantageously used as heat polymerization initiators. There may also be used organic peroxide free radical initiators such as diacylperoxides, peroxyketals, ketone peroxides, hydroperoxides, dialkylperoxides, peroxyesters and peroxydicarbonates. Specifically, there may be mentioned lauroyl peroxide, benzoyl peroxide, cyclohexanone peroxide, 1,1-bis(t-butylperoxy) 3,3,5-trimethylcyclohexane and t-butylhydroperoxide. Alternatively, a persulfate/bisulfite combination may be used. The amount of the heat polymerization initiator to be used with the heat polymerizable binder component will generally be in the range of about 0.001 to 5 parts by weight with respect to 100 parts by weight of the (meth)acrylic monomer, its partial polymer, or a mixture of the monomer and the partial polymer. If the amount of heat polymerization initiator added is less than 0.001 part by weight it will not be possible to achieve the desired heat polymerization, while if it is greater than 5 parts by weight, problems may occur depending on the type of heat polymerization initiator, such as generation of gas due to rebonding of free radicals in the cage, or increased crosslinking reaction due to attraction of hydrogen. The amount of heat polymerization initiator added is preferably in the range of about 0.05 to 3 parts by weight.

### Foaming Agent

The foam sheet-forming composition of the invention further comprises a foaming agent to produce foaming reaction with the heat polymerization reaction when the (meth)acrylic monomer or its partial polymer is heat polymerized.

There are no particular restrictions on the foaming agent used to carry out the invention, and foaming agents commonly used for plastic materials are encompassed. Suitable foaming agents include chemical foaming agents which generate gas upon heating, and examples are inorganic foaming agents, organic foaming agents, thermal expanding microcapsules and the like. More specifically, examples of suitable inorganic foaming agents include ammonium carbonate, sodium hydrogen carbonate, ammonium hydrogen carbonate and ammonium nitrite, examples of suitable organic foaming agents include nitroso-based foaming agents such as dinitrosopentamethylenetetramine (DPT), sulfohydrazide-based foaming agents such as benzenesulfonylhydrazide, p-toluenesulfonylhydrazide, p,p′-oxybis(benzenesulfonylhydrazide) (OBSH), 3,3′-disulfonehydrazidediphenylsulfone, toluenedisulfonylhydrazide, p-toluenesulfonylhydrazone, p,p′-thiobis(benzenesulfonylhydrazone), p-toluenesulfonylazide or p-toluenesulfonyl semicarbazide and azo-based foaming agents such as azobisisobutyronitrile, azodicarbonamide (ADCA), barium azodicarboxylate or diethyl azodicarboxylate, as well as compounded agents which are combinations of the aforementioned foaming agents, such as SPANCELL (DPT/ADCA-based compound foaming agent by Eiwa Chemical Ind. Co., Ltd.) (Eiwa) or EXCELLAR (ADCA/OBSH-based compound foaming agent by Eiwa), and examples of suitable heat expanding microcapsules include Matsumoto Microsphere F Series (product of Matsumoto Yushi-Seiyaku Co., Ltd.), CELLPOWDER (product of Eiwa) and the like. These foaming agents may be used alone, or a mixture of two or more of the aforementioned foaming agents may be used. The foaming agent will usually be used in an amount of about 0.1 to 20 parts by weight to 100 parts by weight of the (meth)acrylic monomer. If the amount of the foaming agent is less than 0.1 part by weight a sufficient quantity of bubbles may not be produced, whereas if the amount is greater than 20 parts by weight the quantity of bubbles will increase, resulting in a problem whereby the sheet will not exhibit adequate cohesion. The foaming agent is preferably added in an amount in the range of about 0.3 to 10 parts by weight to 100 parts by weight of the (meth)acrylic monomer.

In some cases, the decomposition temperature may be appropriately adjusted using a foaming aid for the foaming agent. Examples of foaming aids include urea-based aids, organic acid-based aids such as salicylic acid, stearic acid and lauric acid, and metal-based aids such as zinc, calcium, lead and barium salts of fatty acids.

### Other Components

The foam sheet-forming composition of the invention may also contain other desired components in addition to the aforementioned components.

Crosslinking Agent:

A crosslinking agent may be used to enhance the strength of the heat conductive composition when it has been worked into a sheet. As crosslinking agents there may be used crosslinking agents which can be activated by heat. These include lower alkoxylated aminoformaldehyde condensates, having 1 to 4 carbon atoms in the alkyl group, hexamethoxymethylmelamines (for example, Cymell™ 303 by American Cyanamide) or tetramethoxymethylureas (for example, Beetle™ 65 by American Cyanamide). Other useful crosslinking agents include polyfunctional acrylates such as 1,6-hexanedioldiacrylate and tripropyleneglycol diacrylate. These crosslinking agents may be used alone or as combinations of two or more crosslinking agents. The crosslinking agent will normally be used in an amount of about 0.001 to 5 parts by weight to 100 parts by weight of the monomer.

Chain Transfer Agent:

A chain transfer agent may be used to control the molecular weight of the acrylic polymer obtained by polymerization of the heat polymerizable binder component. As such chain transfer agents there may be mentioned mercaptanes, disulfides, carbon tetrabromide, carbon tetrachloride and the like. A chain transfer agent will usually be used in an amount of about 0.01 to 1.0 part by weight to 100 parts by weight of the (meth)acrylic monomer or its partial polymer.

The foam sheet-forming composition of the invention may further contain, in addition to the components mentioned above, other additives such as tackifiers, antioxidants, plasticizers, flame retardants, anti-settling agents, thickening agents such as acrylic rubber or epichlorhydrin rubber, thixotropic agents such as ultrafine powdered silica, surfactants, foam stabilizers, antifoaming agents, coloring agents, conductive particles, antistatic agents, organic fine particles, ceramic bubbles and the like, so long as the heat conductivity is not impaired. Such additives may be used alone or in combinations of two or more.

The heat polymerizable, foam sheet-forming composition described above may be used to produce a heat conductive foam sheet according to the invention. The process for producing the foam sheet of the invention is not particularly restricted so long as it allows a molded article to be formed by heat polymerization of the sheet-forming composition of the invention. The heat conductive foam sheet of the invention is preferably produced by the following steps:

a step of preparing a foam sheet-forming composition,

a step of molding the composition into a sheet, and

a step of heating the composition either during or after the sheet-molding step to simultaneously accomplish reactions for heat polymerization of the binder component and foaming of the composition.

In the first step, a foam sheet-forming composition is prepared. It may be prepared by combining a heat polymerizable binder component comprising the (meth)acrylic monomer or a partial polymer obtained by partial polymerization of the (meth)acrylic monomer, or a mixture of the monomer with its partial polymer, and a heat conductive filler, heat polymerization initiator, foaming agent and, if necessary, a crosslinking agent, surface treating agent, chain transfer agent and other additives, to form a heat polymerizable composition (heat conductive composition precursor).

In the preparation step, the (meth)acrylic monomer used may be one having acidic, neutral or basic polarity in the molecule. The heat conductive filler used may also be one having acidic, neutral or basic polarity in the molecule. The (meth)acrylic monomer and heat conductive filler used in combination may have the same or different polarity. The heat polymerization initiator used may be any of the same ones mentioned above for the partial polymerization. Two or more heat polymerization initiators with different half-lives may also be used to form the heat polymerizable mixture. The foaming agent may be any one mentioned above.

The heat conductive composition precursor prepared in the manner described above is then subjected to mixing, while deairing, with a planetary mixer. The resulting heat polymerizable mixture may be utilized as a heat conductive adhesive by heat polymerization at about 50 to 200° C. after being filled as a liquid between locations to be bonded. Alternatively, the heat polymerizable mixture may be subjected to heat polymerization reaction by heating at about 50 to 200° C. to obtain a heat conductive foam sheet of the invention. The heating time may be varied in a wide range depending on the intended heat polymerization. According to the invention, heating for the heat polymerization reaction simultaneously produces a foaming reaction due to the foaming agent. That is, the heat polymerization and foaming reactions may be conducted simultaneously (or approximately simultaneously) in a single heating step.

During production of the heat conductive foam sheet, the heat polymerization is preferably carried out after applying or coating the sheet-forming composition onto a support surface such as a liner and forming a sheet by calender molding or press molding, to thereby obtain a heat conductive foam sheet according to the invention. The sheet formation may be accomplished in an inert atmosphere of nitrogen or the like so as avoid inhibition of polymerization by oxygen. According to the invention it is possible to fill the heat conductive filler to a very high fill factor compared to the prior art, thereby allowing a sheet to be obtained having a high heat conductivity of 2 W/mK or greater.

The heat conductive sheet of the invention has a foam structure with a void volume of usually in the range of about 5 to 50 vol % based on the total volume of the heat conductive sheet, and preferably in the range of about 10 to 40 vol %. If the void volume of the heat conductive foam sheet is less than 5 vol %, the number of included bubbles will be too small and it will not be possible to obtain a sheet having the desired flexibility and high heat conductivity, while if it is greater than 50 vol %, it will not be possible to obtain a sheet having sufficient cohesion. The “void volume” of the heat conductive foam sheet may be defined as follows.

Setting the volume of the heat conductive foam sheet (sample) as V (cm³), the mass of the sample as m (g), the volume of pores in sample and the volume of the binder as V_{P} and V_{B} respectively and the specific gravities of the pores and binder as d_{P} (g/cm³) and d_{B} (g/cm³), respectively, the following two formulas may be derived:

V=V_{P}+V_{B}

m=d_{P}V_{P}+d_{B}V_{B}

Since d_{P} is much smaller than d_{B}, this may be expressed as:

m=V_{B}·d_{B}

Thus, the void volume (vol %) can be calculated according to the following formula.

$$\begin{matrix}Void volume ( vol \% ) = {V}_{P} / V \times 100 \\ = ( V - {V}_{B} ) / V \times 100 \\ = \{ 1 - m / ( V \cdot {d}_{B} ) \} \times 100\end{matrix}$$

The heat conductive foam sheet of the invention can be used for bonding of electronic parts, and particularly semiconductors or electronic parts such as power transistors, graphic ICs, chip sets, memory chips, central processing units (CPUs) and the like, to heat sinks or heat radiators. The thickness of the heat conductive foam sheet will be determined mainly in consideration of the heat resistance of the applied location. The sheet thickness will in most cases be preferably no greater than 5 mm to reduce heat resistance, but it will sometimes be used to fill in larger gaps between heat generating parts and heat radiating parts, while sheets with thicknesses of greater than 5 mm may sometimes be suitable for following irregularities on part surfaces. When a sheet with a thickness of greater than 5 mm is suitable, the sheet thickness is more preferably less than 10 mm. The lower limit for the sheet thickness will normally be about 0.2 mm.

The heat conductive foam sheet of the invention may also have an additional member on the surface of and/or inside the foam sheet. For example, a layer of the heat conductive sheet-forming composition may be formed on a support or substrate which is releasable or has been release-treated with respect to the composition, to provide a composite or laminated heat conductive foam sheet. In such cases, release from the support or substrate at the time of use will allow application of the heat conductive foam sheet as an independent film. Otherwise, the heat conductive foam sheet may be used while anchored on the support or substrate to enhance the strength of the sheet. Examples of supports or substrates include polymer films, and examples of films which may be used include those made of polyethylene, polypropylene, polyimide, polyethylene terephthalate, polyethylene naphthalate, polytetrafluoroethylene, polyetherketone, polyethersulfone, polymethylterpene, polyetherimide, polysulfone, polyphenylene sulfide, polyamidoimide, polyesterimide, aromatic amides and the like. When particularly high heat resistance is required, a polyimide film or polyamidoimide film is preferred. The heat conductivity may be further increased by including a heat conductive filler in the support or substrate. Other supports or substrates which may be mentioned include metal foils such as aluminum or copper and woven fabrics, nonwoven fabrics or scrims formed from glass fiber, carbon fiber, nylon fiber, polyester fiber or such fibers coated with metal coatings. The support or substrate may lie on one or both sides of the heat conductive sheet, or alternatively it may be embedded into the heat conductive foam sheet.

The heat polymerizable sheet-forming composition of the invention has a high heat conductive filler content and exhibits satisfactory heat conductivity. In addition to heat conductivity, the dynamic properties such as tensile strength and compressibility are especially important properties when the composition is used for working into a heat conductive foam sheet. That is, the heat conductive foam sheet must have sufficiently high tensile strength so as not to tear when it is attached or reattached, and it must have a sufficiently low compressive stress so as not to create an excessive load on electronic parts when incorporated into electronic devices. In order to obtain a heat conductive sheet exhibiting suitable dynamic properties it is important to control the chemical structure of the acrylic polymer composing the binder. The present inventors have found that an acrylic polymer suitable as a binder can be obtained by crosslinking the sparsely intertwined acrylic polymer chains with a crosslinking agent such as a polyfunctional acrylate.

For a heat conductive foam sheet comprising a heat conductive filler at about 30 to 90 vol %, the viscoelastic properties of the acrylic polymer as the binder are such that the shearing storage modulus (G′) at a frequency of 1 Hz at room temperature (20° C.) is about 1.0×10³ to 1.0×10⁵ Pa, and the loss tangent (tan δ) is in the range of about 0.2 to 0.8. Such viscoelastic properties represent a range for suitable crosslinking. On the other hand, the degree of intertwining of the polymer chains is dependent largely on the molecular weight, with a lower molecular weight resulting in polymer chains with less intertwining. Considering the non-crosslinked polymer chains, therefore, the number average molecular weight to give a preferred degree of intertwining is less than about 200,000.

If the shearing storage modulus (G′) is lower than the aforementioned range the tensile strength may be too low, while if it is above that range the compressive strain at a fixed compressive stress will be too low, or in other words, the compressive stress will tend to be too high with a fixed strain. Also, if the loss tangent (tans) is lower than the aforementioned range the compressive strain will tend to be too low, while if it is higher than the aforementioned range, the tensile strength will tend to be too low.

Thus, the acrylic polymer of the binder is an acrylic polymer obtained from the aforementioned (meth)acrylic monomer, wherein the number average molecular weight of the polymer chains is less than about 200,000, with crosslinking such that the shearing storage modulus (G′) at a frequency of 1 Hz at 20° C. is about 1.0×10³ to 1.0×10⁵ Pa, and the loss tangent (tan δ) is in the range of about 0.2-0.8.

As general methods for obtaining low molecular weight polymers by thermal radical polymerization, there may be mentioned increasing the amount of the heat polymerization initiator, conducting the polymerization at a higher temperature than the decomposition temperature of the heat polymerization initiator used, and using a chain transfer agent. Since a large amount of radicals are generated during the initial reaction under these conditions and the generated radicals polymerize and are thus effectively consumed, the resulting polymer is of low molecular weight. Specifically, an acrylic polymer with its molecular weight satisfactorily controlled to less than 200,000 can be obtained when:

(1) the heat polymerization initiator is added at 0.1 to 10 parts by weight to 100 parts by weight of the (meth)acrylic monomer for polymerization,

(2) lauroyl peroxide (10-hour half decomposition temperature: 61.6° C.) is used and polymerization is conducted at 80 to 200° C.,

(3) a chain transfer agent is added at 0.01 to 0.1 part by weight for polymerization, or

(4) the aforementioned methods are combined for polymerization.

By using a crosslinking agent in an amount of 0.01 to 5 parts by weight to 100 parts by weight of the (meth)acrylic monomer under these conditions, it is possible to obtain an acrylic polymer with the viscoelastic properties specified above.

It was also found that by using a specific low molecular weight acrylic polymer instead of a conventional plasticizer in a sheet-forming composition of the invention containing an abundant amount of heat conductive filler and exhibiting high heat conductivity, it is possible to obtain a highly heat conductive composition having increased flexibility, pliability and adhesion during use, thus resulting in reduced heat resistance at the contact interface. This effect of using a low molecular weight acrylic polymer, which is not obtained when a low molecular weight acrylic polymer is not used, becomes more notable with a higher heat conductive filler content in the sheet-forming composition of the invention. As additional advantages, no bleed out occurs since the low molecular weight acrylic polymer is more compatible with the composition than a conventional plasticizer, and contamination during use is avoided since it is of higher molecular weight than a conventional plasticizer and thus undergoes virtually no volatilization.

A low molecular weight acrylic polymer suitable for use as a plasticizer for carrying out the invention is a liquid at ordinary temperature and has a Tg of no higher than 20° C. Such acrylic polymers are composed mainly of acrylic acid ester monomers, with the ester portions consisting of 1 to 20 carbons. As acrylic acid esters having ester portions of 1 to 20 carbons there may be mentioned alkyl acrylates such as methyl acrylate, ethyl acrylate, propyl acrylate, isopropyl acrylate, butyl acrylate, isobutyl acrylate, s-butyl acrylate, t-butyl acrylate, neopentyl acrylate, 2-ethylhexyl acrylate, isodecyl acrylate, lauryl acrylate, tridecyl acrylate and stearyl acrylate. These may be used alone or in combinations of two or more. A low molecular weight acrylic polymer may also be copolymerized with a non-acrylic acid ester monomer which is copolymerizable therewith. As copolymerizable monomers there may be mentioned vinyl-based monomers such as methacrylic acid esters, α-olefins, vinyl esters and vinyl ethers. The low molecular weight acrylic polymer may be produced by an ordinary method such as suspension polymerization or emulsion polymerization in an aqueous medium, solution polymerization in an organic solvent, or bulk polymerization. The glass transition temperature of the acrylic polymer is no higher than 20° C. and preferably no higher than 0° C. The weight-average molecular weight is from 500 to 100,000 and preferably from 700 to 20,000. If the glass transition temperature is above 20° C., it may not be possible to obtain a heat conductive foam sheet with high flexibility and adhesion. If the weight-average molecular weight exceeds 100,000, adequate plasticity may not be exhibited and the workability into a heat conductive foam sheet may thus be impaired, while if it is less than 500 the cohesion of the sheet may be reduced, thereby resulting in poor handling property. The low molecular weight acrylic polymer may be produced using the aforementioned chain transfer agent in an amount of 0.01 to 1.0 part by weight to 100 parts by weight of the (meth)acrylic monomer. Also, during polymerization of the heat conductive composition precursor and particularly when conducting partial polymerization, a chain transfer agent may be added to form a low molecular weight acrylic polymer suitable as a plasticizer directly in the composition.

The amount of the low molecular weight acrylic polymer added will normally be about 1 to 100 parts by weight, and preferably about 5 to 70 parts by weight, to 100 parts by weight of the monomer or partial polymer. At less than 1 part by weight, the effect as a plasticizer is minimal. At greater than 100 parts by weight, excessive adhesion may be exhibited resulting in poor manageability and lowering the physical strength including the tensile strength.

The term “acrylic polymer having substantially no functional groups” used in reference to the low molecular weight acrylic polymer means that the (meth)acrylic monomer or its partial polymer has substantially no functional groups that can react with the heat polymerization initiator or crosslinking agent.

### EXAMPLES

The present invention will now be explained in further detail by way of examples. However, it should be noted that the invention is in no way limited by these examples.

### Example 1

### Fabrication of Heat Conductive Foam Sheet

First, 100 parts by weight of 2-ethylhexyl acrylate (2-EHA) and 0.04 part by weight of an ultraviolet polymerization initiator (2,2-dimethoxy-1,2-diphenylethan-1-one, “IRGACURE™ 651” by Ciba-Specialty Chemical) were mixed in a glass container and then an ultraviolet ray source with maximum intensity in a wavelength range of 300 to 400 nm was used for irradiation of ultraviolet rays with an intensity of 3 mW/cm² from a low-pressure mercury lamp in a nitrogen gas atmosphere. This produced a partial polymer of the (meth)acrylic monomer having a viscosity of approximately 1000 centipoise (cP). The partial polymer was a viscous liquid with 10 to 20% polymerization of the total monomer.

Next, the components listed in Table 1 below were prepared in the listed amounts, and each component was deaired and kneaded with a mixer. The resulting mixture (sheet-forming composition) was sandwiched between two polyethylene terephthalate (PET) liners coated with a silicone release agent, and calender molded to a thickness of 0.8 mm. The resulting molded sheet was heated for 15 minutes in an oven at 140° C. for heat polymerization. The heating step promoted heat polymerization of the partial polymer in the mixture while simultaneously causing foaming reaction due to the foaming agent. Upon completion of the reaction, a 1.3 mm thick (excluding liners) heat conductive foam sheet was obtained.

Evaluation Test

A heat conductive foam sheet fabricated in the manner described above was subjected to a test for three parameters: (1) void volume, (2) load for compression at a 20% compressibility ratio and (3) heat conductivity.

(1) Measurement of Void Volume

The heat conductive foam sheet was released from the liner and cut into a 10 mm×10 mm rectangular sample. The volume V (cm³) and mass m (g) of the sample were measured, while the specific gravity d (g/cm³) of a sample for Comparative Example 1 having no bubble structure was also measured, and the measured values were entered into the following formula to determine the void volume (vol %).

Void volume (vol %)={1−m/(V·d)}×100

As shown in Table 1 below, the void volume was 29.1 vol %.

(2) Measurement of Load for Compression at 20% Compressibility Ratio

The heat conductive foam sheet was released from the liner and cut into a 10 mm×10 mm square sample. The change in load and thickness of the sample when compressed at a rate of 0.5 mm/min were measured, and the compressibility ratio was determined by the following formula.

Compressibility ratio (%)=(initial thickness−thickness under compression)/initial thickness

Next, a graph was drawn to show the relationship between compressibility ratio and load, and the load (N/cm²) for 20% compression was determined from the approximated curve. The target compressibility ratio was 20% because a heat conductive sheet is usually under about 20% compression during actual use.

As shown in Table 1 below, the load for a 20% compressibility ratio was 6.9 N/cm².

(3) Measurement of Heat Conductivity

The heat conductive foam sheet was released from the liner and cut into a 10 mm×11 mm rectangular sample. Using a heat conductivity measuring instrument produced internally, the sample was inserted between the heating element and cooling plate and an electrical power of 4.76 W was applied while under a fixed load of 7 N/cm². The temperature difference between the heating element and cooling plate was measured and the heat resistance (degC·cm²/W) was determined according to the following formula.

Heat resistance=temperature difference(degC)×area(cm²)/power(W)

As shown in Table 1 below, the heat resistance was 6.75 degC·cm²/W.

### Comparative Example 1

The procedure described in Example 1 was repeated, but for this comparative example a heat conductive sheet with no foam structure was fabricated.

The components listed in Table 1 were prepared in the listed amounts, and each component was deaired and kneaded with a mixer. The resulting mixture was sandwiched between two PET liners in the manner described in Example 1 and calender molded to a thickness of 0.8 mm. The resulting molded sheet was heated for 15 minutes in an oven at 140° C. for heat polymerization. The heating step promoted heat polymerization of the partial polymer in the mixture (sheet-forming composition), but no foaming reaction occurred since no foaming agent had been added. Upon completion of the reaction, a 1.3 mm thick (excluding liners) heat conductive sheet was obtained.

The obtained heat conductive sheet was subjected to a test for three parameters: (1) void volume, (2) load for compression at a 20% compressibility ratio and (3) heat conductivity, according to the same procedures described in Example 1. The obtained test results are shown in Table 1.

TABLE 1

| | Example 1 | Comp. Ex. 1 |
|---|---|---|
| Binder component (pts. by wt.) | | |
| Partial polymer | 40 | 40 |
| 2EHA | 60 | 60 |
| HDDA | 0.3 | 0.3 |
| Irganox ™ 1076 | 0.3 | 0.3 |
| TMCH | 0.8 | 0.8 |
| NEOCELLBORN ™ N#5000 | 1.0 | — |
| Sheet-forming composition (pts. by vol.) | | |
| Binder component | 40 | 40 |
| Heat conductive filler component (total) | 60 | 60 |
| Silicon carbide | 40 | 40 |
| Aluminum hydroxide | 20 | 20 |
| Void volume (vol %) | 29.1 | 0 |
| Load for 20% compression (N/cm²) | 6.9 | 83.5 |
| Heat resistance (degC · cm²/W) | 6.75 | 6.15 |

Notes:
2-EHA: 2-ethylhexyl acrylate
HDDA: 1,6-hexanedioldiacrylate
Irganox ™ 1076: antioxidant (Ciba-Specialty Chemical)
TMCH: 1,1-bis(t-butylperoxy) 3,3,5-trimethylcyclohexane
NEOCELLBORN N#5000: sulfohydrazide-based foaming agent (Eiwa Chemical Ind. Co., Ltd.)
Silicon carbide: 70 μm mean particle size
Aluminum hydroxide: 2 μm mean particle size (titanate-treated)

As will be readily understood from the test results shown in Table 1, a 20% compressibility ratio was achieved with a load of 6.9 N/cm² in Example 1, but in Comparative Example 1 a load of approximately 12 times that load, or 83.5 N/cm², was necessary. This demonstrated that the heat conductive foam sheet fabricated in Example 1 had an excellent shape following property and required no excessive load for practical use, and that consequently the dynamic load on parts due to compressive load can be minimized.

The heat resistances measured for Example 1 and Comparative Example 1 were approximately equivalent. The heat conductive foam sheet of Example 1 would normally be expected to have lower heat resistance due to the inclusion of bubbles, but the adverse effect of the bubbles on heat resistance was clearly reduced by use under compression.

These results demonstrated that the heat conductive foam sheet of Example 1 had an excellent compression property, satisfactory shape following property for different surface forms with fine irregularities, and high heat conductivity.

### Example 2

The procedure described in Example 1 was repeated, but for this example KS (azo/sulfohydrazide-based compound foaming agent by Eiwa Chemical Ind. Co., Ltd.) (Eiwa) was used as the foaming agent in the same amount (1.0 part by weight) instead of the NEOCELLBORN™ N#5000 used in Example 1. The thickness of the obtained heat conductive foam sheet was 1.2 mm.

The obtained heat conductive foam sheet was subjected to a test for the three parameters of void volume, load for compression at a 20% compressibility ratio and heat conductivity, according to the same procedures described in Example 1, giving the following test results.

Void volume: 27.3 vol %

Load for 20% compression: 3.4 N/cm²

Heat resistance: 7.09 deg·cm²/W

The heat resistance, as measured with application of a fixed load of 22 N/cm² instead of 7 N/cm², was 6.08 deg·cm²/W.

### Example 3

The procedure described in Example 1 was repeated, but for this example 3.0 parts by weight of CELLPOWDER E30 (mixture of sulfohydrazide-based foaming agent and olefin resin by Eiwa) was used as the foaming agent instead of the EOCELLBORN™ N#5000 used in Example 1. The obtained molded sheet was subjected to heat polymerization by heating for 15 minutes in an oven at 160° C. The thickness of the obtained heat conductive foam sheet was 1.2 mm.

The obtained heat conductive foam sheet was subjected to a test for the three parameters of void volume, load for compression at a 20% compressibility ratio and heat conductivity, according to the same procedures described in Example 1, giving the following test results.

Void volume: 26.1 vol %

Load for 20% compression: 3.8 N/cm²

Heat resistance: 6.36 deg·cm²/W

The heat resistance, as measured with application of a fixed load of 22 N/cm² instead of 7 N/cm², was 5.32 deg·cm²/W.

1. A process for producing a heat conductive foam sheet, comprising:
preparing a foam sheet-forming composition comprising, in combination, the following components:
a heat-polymerizable binder component comprising at least one (meth)acrylic monomer or its partial polymer,
a heat conductive filler,
a heat polymerization initiator for said binder component, and
a foaming agent,
molding said composition into a sheet, and
heating said composition either during or after the sheet-molding step to simultaneously accomplish reactions for heat polymerization of said binder component and foaming of said composition.

2. The process for producing a heat conductive foam sheet according to claim 1, in which sheet-molding is carried out by calender molding or press molding either in the presence or in the absence of a liner.

3. The process for producing a heat conductive foam sheet according to claim 1, in which heating is carried out at a temperature of 50 to 200° C.

4. The process for producing a heat conductive foam sheet according to claim 1, in which said (meth)acrylic monomer comprises a (meth)acrylic monomer having an alkyl group of no more than 20 carbons.

5. The process for producing a heat conductive foam sheet according to claim 1, wherein the foam sheet-forming composition further comprises an acrylic polymer which is composed mainly of an acrylic acid ester wherein the ester portion has 1 to 20 carbons, which has a glass transition temperature of no higher than 20° C. and a weight-average molecular weight of from 500 to 100,000, and which has substantially no functional groups.

6. The process for producing a heat conductive foam sheet according to claim 1, wherein said foaming agent comprises an inorganic foaming agent, an organic foaming agent and/or thermal expanding microcapsules.

7. The process for producing a heat conductive foam sheet according to claim 1, wherein said foaming agent is used in an amount of 0.1 to 20 parts by weight with respect to 100 parts by weight of the (meth)acrylic monomer.
